(19) United States
(12) Patent Application Publication
(10) Pub. No.: US 2005/0122236 A1
(43) Pub. Date: Jun. 9, 2005

(54) Moving map information index

(76) Inventors: R. Klaus Brauer, Seattle, WA (US); R. Blake Emery, Enumclaw, WA (US)

Correspondence Address: HARNESS, DICKEY & PIERCE, P.L.C., P.O. BOX 828, BLOOMFIELD HILLS, MI, 48303, US

(21) Appl. No.: 10/730,669

(22) Filed: Dec. 8, 2003

(51) Int. Cl. G08G 1/123

(52) U.S. Cl. 340/995.24; 701/221; 707/10

(57) ABSTRACT

A method is provided for providing information to occupants of a mobile platform. The method includes presenting a moving map to each occupant, wherein the moving map includes a plurality of information icons. The moving map is displayed via at least one passenger display. Each information icon is associated with at least one of a plurality of information modules that include various forms of data in which the occupant may be interested. The method additionally includes presenting to the occupant the information module associated with an information icon selected by the occupant. Thus, the occupant can select an information icon based on the type of desired information and then access the associated information module to view the desired information.

### FIELD OF INVENTION

The invention relates generally to on board information systems for mobile platforms, such as aircraft, buses and trains. More specifically, the invention relates to a system and method for providing occupants of a mobile platform with useful, informative and entertaining information regarding points of interest along the travel path of the mobile platform.

### BACKGROUND OF THE INVENTION

Airline passengers have become isolated form the flying experience. At the same time the overall passenger experience has tended to become somewhat routine. Often passengers have little sense that they are making progress toward their destination, which makes their flight seem longer. Therefore, it would be desirable to provide passengers a form of information that either indicates their progress toward a destination or presents the passengers with information or stories relating to their destination or points of interest along their travel path, or both.

### BRIEF SUMMARY OF THE INVENTION

In one preferred embodiment, the present invention is a method for providing information to occupants, e.g. passengers, of a mobile platform. The method includes presenting a moving map to each occupant, wherein the moving map includes a plurality of information icons. The moving map is displayed via at least one passenger display. Each information icon is associated with at least one of a plurality of information modules that include various forms of data in which the occupant may be interested. For example, the information modules may include data about historical or archeological sites, and/or local culture, flora and fauna. Other examples of information that may be included in the information modules is data about the terrain along the travel path of the mobile platform, data about the destination of the mobile platform, or data about restaurants and other attractions located around the destination of the mobile platform. In one preferred implementation, the method additionally includes presenting to the occupant the information module associated with an information icon selected by the occupant. Thus, the occupant can select an information icon based on the type of desired information and then access the associated information module to view the desired information.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and accompanying drawings, wherein;

FIG. 1 is a block diagram of a system for providing information and entertainment to occupants of a mobile platform, in accordance with one preferred embodiment of the present invention;

FIG. 2 is a schematic of a section of a mobile platform passenger cabin area wherein the system shown in FIG. 1 is implemented; and

FIG. 3 is an illustration of a graphical panel displaying the moving map in accordance with a preferred embodiment of the present invention.

Corresponding reference numerals indicate corresponding parts throughout the several views of drawings.

### DETAILED DESCRIPTION OF THE INVENTION

The following description of various preferred embodiments is merely exemplary in nature and is in no way intended to limit the invention, its application or uses. As described below, the present invention is directed to a system and method for providing occupants, e.g. passengers, of a mobile platform with travel information and entertainment. Although the preferred embodiments are described in reference to aircraft, the invention should not be so limited in application. It is envisioned that the invention is applicable to aircraft, trains, buses, ships, and/or other forms of mobile platforms.

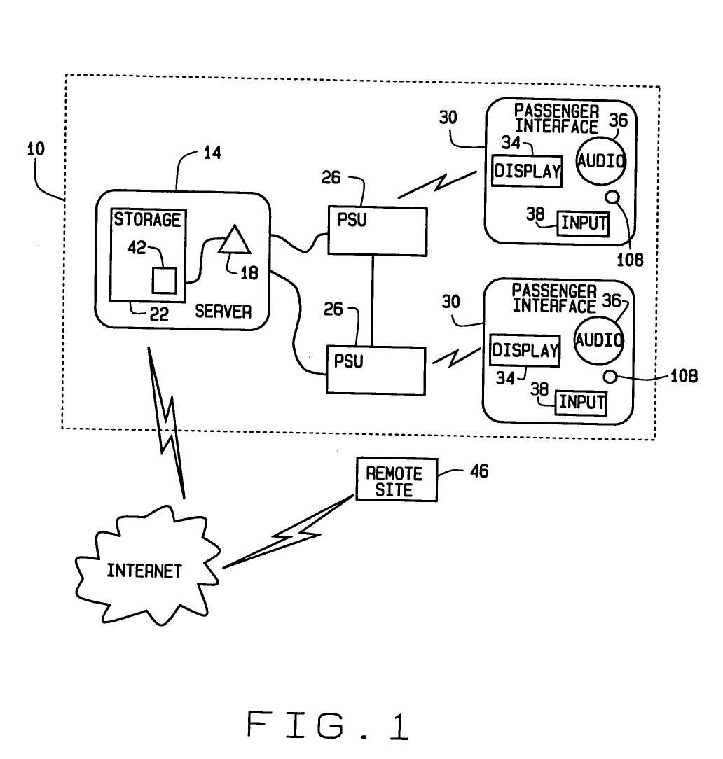

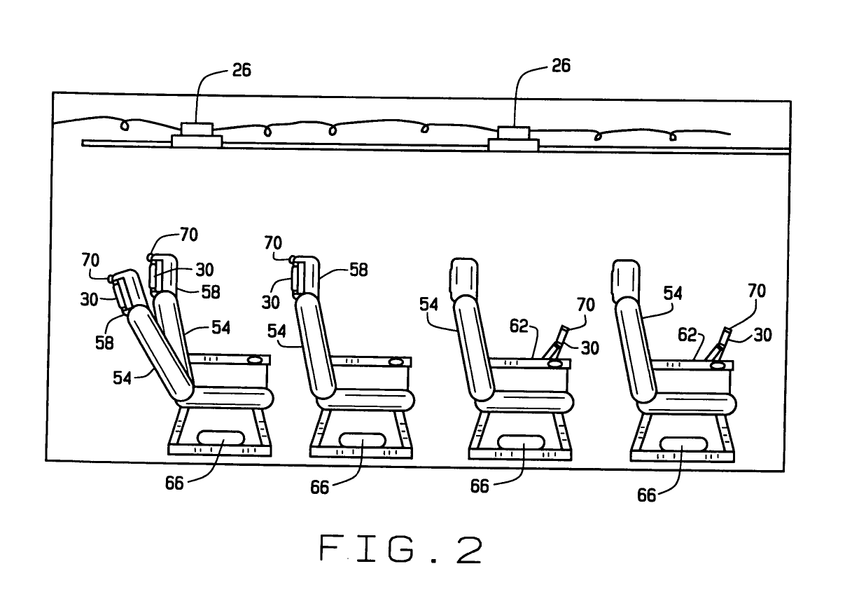

FIG. 1 is a block diagram of a system 10 for providing passenger of a mobile platform, such as an aircraft, with information and entertainment, in accordance with a preferred embodiment of the present invention. As used herein the term passenger is intended to mean any occupant of the mobile platform, including crew members and traveling customers of the mobile platform. The system 10 provides data and information regarding geographical regions along the travel path of the mobile platform and/or other information such as ground speed, outside air temperature, altitude and time/distance to a point of interest. The system 10 is an onboard local area network (LAN). System 10 includes a server 14 that includes a processor 18 suitable to execute all functions of server 14, and at least one electronic storage device 22. The electronic storage device 22 preferably comprises a computer readable medium, such as a hard drive or any other electronic data storage device for storing such things as software packages or programs, algorithms, information and data. In an alternate embodiment, the electronic storage device 22 is independent of and electrically connected to the server 14. Additionally, system 10 includes a plurality of zone distribution units (ZDUs) 26 connected for communication with each other, e.g. hard wired or wirelessly connected, to server 14. The ZDUs 26 are preferably located in an overhead compartment above a plurality of seats in a passenger compartment of the mobile platform, as shown in FIG. 2.

Additionally, system 10 includes a plurality of passenger interfaces 30 communicatively connected, e.g. hard wired or wirelessly connected, to the ZDUs 26. Each passenger interface 30 includes a display 34 for viewing such things as a moving map, information, data and other graphical representations. Each passenger interface 30 additionally includes an audio listening device 36, such as a headset and jack or a speaker, for audibly presenting information to passengers. Each passenger interface 30 preferably also includes a data input device 38 that allows a passenger to input information, data and/or queries to server 14. For example, the data input device 38 can be a keyboard, a mouse or a touch screen included in the display 34.

The electronic storage device 22 includes at least one database 42 for storing groups of information and data. In a preferred embodiment, the database 42 electronically stores information modules pertaining to information and data regarding geographical regions along the travel path of the mobile platform. For example, database 42 can store information modules regarding various locations, structures, cities, land masses, water masses, historical facts, etc. that relate to geographical regions along the travel path of the mobile platform. The database 42 is included in the storage device 22, however, the database 42 can instead be included in an independent electronic storage device (not shown) separate from and connected to the server 14.

Additionally, server 14 includes a wireless modem (not shown) such that system 10 can access the Internet, such as a wide area network, using a broadband signal. Therefore, the system 10 can access a remote site 46, such as a remote terrestrial server system, using the broadband signal.

FIG. 2 illustrates a section of a mobile platform passenger cabin area 50 wherein system 10 is utilized in accordance with a preferred embodiment of the present invention. The passenger cabin area 50 includes a plurality of passenger seats 54. The passenger interfaces 30 are located within the passenger cabin area 50 at any location conveniently accessible by a passenger. For example, the passenger interfaces 30 can be integrated with a head rest portion 58 of some or all of the passenger seats 54, or integrated with an armrest 62 of some or all of the passenger seats 54.

The system 10 includes a plurality of dedicated seat electronics boxes (SEBS) 66 that communicatively connect the passenger interfaces 30 with the ZDUs 26. The SEBs 66 receive audio/video information and other data from the server 14, via the ZDUs 26, and transmit the information and data to the passenger interfaces 30. Similarly, the SEBs 66 receive data and queries from the passenger interfaces 30 and transmit the data and queries to the sever 14, via the ZDUs 26.

In an alternate preferred embodiment, system 10 includes a plurality wireless network interface circuits (NICs) 70 at each passenger seat 54. The NICs 70 wirelessly link the passenger interfaces 30 with the ZDUs 26. In one preferred embodiment, the NICs 70 are integrated into the passenger interfaces 30. The NICs 70 wirelessly receive audio/video entertainment information and other data from the server 14, via the ZDUs 26, and transmit the information and data to the passenger interfaces 30. Similarly, the NICs 70 receive data and queries from the passenger interfaces 30 and wirelessly transmit the data and queries to the server 14, via the ZDUs 26.

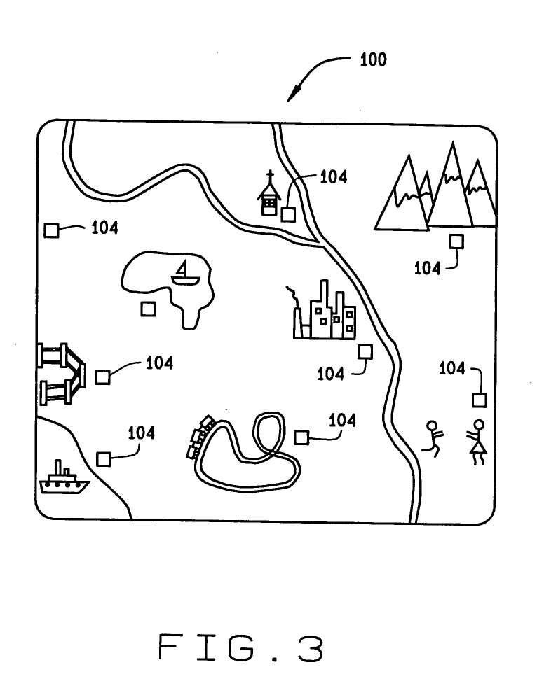

FIG. 3 is an illustration of a graphical panel illustrating a moving map 100 in accordance with a preferred embodiment of the present invention. The moving map 100 is displayed on displays 34 so that passengers can view the moving map 100 as the mobile platform moves along its travel path. The moving map 100 is a graphical real time representation of the geographical region the mobile platform is currently traversing. More specifically, as the mobile platform advances along its travel path, the moving map 100 displayed on the displays 34 is continuously updated by the server 14 to illustrate the geographical region presently being traversed. In addition to the geographic region, the moving map includes information icons 104 that indicate various points of interest along the travel path, such as tourist attractions, architectural structures, cities, land masses, water masses and locations of historical events. Each information icon 104 is associated with at least one information module containing information and/or stories about the point of interest indicated by the associated information icon 104. Additionally, each information icon 104 can include other information such as information pertaining to hotels and restaurants in or around a specific location, and/or a distance to or from a specific destination.

In a preferred embodiment, each information module is stored in database 42. In this embodiment, each icon 104 is electronically linked to at least one associated information module. Therefore, to retrieve an information module, the passenger utilizes the input device 38 to select an icon of interest. The passenger interface 30 then transmits the query to the server 14, via the ZDU 26. Thereafter, the server 14 returns the associated information module to the passenger interface 30. The information contained in the information module can be visually presented to the passenger via the display 34 and/or audibly presented via the speaker 36. The information contained in the information module can be visually displayed in text form, e.g. a pop-up dialog box, and/or graphical form, e.g. pictorial form.

In an alternate preferred embodiment, each information module is incorporated into at least one information manual stored at a location in the passenger cabin area 50 easily accessible by the passenger. For example, the information manual can be a magazine or booklet stored in seat back pockets (not shown) included in each passenger seat 54. The information manuals may comprise the information included in each information module and would be appropriately marked with a plurality of identifiers that link each information module with the associated information icon 104. Furthermore, each information icon 104 could be distinguishable from all other information icons 104, and the identifiers could be images of the distinguishable information icons 104. In another alternate preferred embodiment, each information icon 104 could have a number displayed next to it on the moving map 100. The number displayed correlates to a page in the information manual on which the desired information module is located. Therefore, to retrieve an information module, the passenger views the moving map 100 and selects an information icon 104 of interest. In addition to the information icons 104, the moving map 100 displays a specific identifier associated with each information icon 104 and associated information module in the information manual. Thus, the passenger views the identifier illustrated in the moving map 100, retrieves the information manual and locates the desired information module within the information manual identified with the corresponding identifier.

In an alternate preferred embodiment, the plurality of passenger displays 34 included in passenger interfaces 30 is replaced with at least one multiple passenger display viewable by a plurality of passengers. For example, the passenger display 34 can be one main screen that is viewed by a plurality of passengers. The passengers can then access desired information modules utilizing the information manuals, as described above.

Referring to FIG. 1, in another alternate preferred, the passenger interfaces 30 include a connection port 108 adapted to allow a passenger to connect a personal computing device, such as a laptop computer, to system 10. Therefore, the passenger can access the moving map and information modules, as described above, by electronically connecting the personal computing device to server 14, via the port 108.

Therefore, the invention thus provides a means for passengers to retrieve interesting and entertaining information regarding points of interest along their travel path and/or their destination utilizing the moving map 100 presented on the display 34 to access the information modules, as described above.

While the invention has been described in terms of various specific embodiments, those skilled in the art will recognize that the invention can be practiced with modification within the spirit and scope of the claims.

1. A method for providing information to occupants of a mobile platform, said method comprising:
presenting a moving map that includes a plurality of information icons to at least one occupant of the mobile platform, via at least one passenger display;
associating each information icon with at least one of a plurality of information modules; and
presenting to the occupant the information module associated with an information icon selected by the occupant.

2. The method of claim 1, wherein associating each information icon comprises:
electronically storing each information module in a database; and
electronically linking each information icon to the associated information module stored in the database.

3. The method of claim 2, wherein presenting to the occupant the information module associated with an information icon selected by the occupant comprises visually presenting the information module on the passenger display when the occupant selects the information icon using a passenger interface.

4. The method of claim 3, wherein visually presenting the information module comprises presenting the information module in text form on the passenger display.

5. The method of claim 3, wherein visually presenting the information module comprises presenting the information module in pictorial form on the passenger display.

6. The method of claim 2, wherein presenting to the occupant the information module associated with an information icon selected by the occupant comprises audibly presenting the information module to the occupant via an audio device when the occupant selects the information icon using a passenger interface.

7. The method of claim 1, wherein associating each information icon comprises;
incorporating the information modules into at least one information manual; and
identifying each information module within the information manual with an identifier that corresponds to the associated information icon.

8. The method of claim 7, wherein presenting to the occupant the information module associated with an information icon selected by the occupant comprises providing the occupant access to the information manual, wherein the occupant can locate the information module that relates to the selected information icon within the information manual using the corresponding identifier.

9. A system for providing information to occupants of a mobile platform, said system comprising:
at least one passenger display adapted to present a moving map that includes a plurality of information icons to at least one occupant of the mobile platform,
at least one storage device for storing at least one information module associated with at least one of the information icons; and
a means for presenting to the occupant the information module associated with an information icon selected by the occupant.

10. The system of claim 9, wherein the storage device comprises a database having the information modules electronically stored therein, wherein each information module is electronically linked to at least one associated information icon.

11. The system of claim 10, wherein the system further comprises a passenger interface device associated with each passenger display.

12. The system of claim 11, wherein the means for presenting to the occupant the information module associated with an information icon selected by the occupant comprises the passenger display, whereby the information module is visually presented to the occupant when the occupant selects the information icons using the passenger interface.

13. The system of claim 11, wherein the means for presenting to the occupant the information module associated with an information icon selected by the occupant comprises an audio device adapted to audibly present to the occupant the information module associated with the information icon selected by the occupant using the passenger interface.

14. The system of claim 9, wherein the storage device comprises at least one information manual having the information modules textually stored therein, wherein each information module is visually linked to at least one associated information icon via a corresponding identifier included in the information manual.

15. The system of claim 14, wherein the means for presenting to the occupant the information module associated with an information icon selected by the occupant comprises the information manual wherein the occupant uses the corresponding identifier to locate within the information manual the information module that relates to the selected information icon.

16. A method for providing information to an occupant of a mobile platform, comprising:
displaying a moving map to the occupant;
presenting at least one information icon on the moving map associated with at least one point of interest within a geographic region being displayed by the moving map;
associating the information icon with predetermined information; and
presenting the predetermined information on the moving map when the occupant selects the information icon.

17. The method of claim 16, wherein presenting the predetermined information comprises presenting the predetermined information in text form in a dialog box on the moving map.

18. The method of claim 16, wherein presenting the predetermined information comprises presenting the predetermined information in graphical form on the moving map.

19. A method for providing information to an occupant of a mobile platform, comprising:
displaying a moving map to the occupant;
presenting at least one information icon on the moving map associated with at least one point of interest within a geographic region being displayed by the moving map;
associating the information icon with predetermined information;
providing the predetermined information in a independent, printed information manual located in a vicinity of the occupant; and
indicating on the moving map where the predetermined information can be obtained in the independent, printed information manual.

20. The method of claim 19, wherein indicating on the moving map comprises displaying an identifier on the moving map that indicates where the predetermined information can be obtained in the independent, printed information manual.

21. The method of claim 19, wherein indicating on the moving map comprises displaying instructions on the moving map as to where the predetermined information can be obtained in the independent, printed information manual, when the occupant selects the information icon.

22. A method for providing information to an occupant of a mobile platform, comprising
displaying a moving map to the occupant corresponding to a path of travel of the mobile platform as the mobile platform traverses a geographic region;
displaying a plurality of information icons on the moving map at various points corresponding to the path of travel, the information icons corresponding to pertinent information about a plurality of points of interest along the path of travel; and
providing predetermined information to the occupant corresponding to the points of interest utilizing the information icons.

23. The method of claim 22, wherein providing predetermined information comprises visually presenting the predetermined information to the occupant on a display displaying the moving map when the occupant selects a given one of the information icons.

24. The method of claim 23, wherein visually presenting comprises at least one of:
textually providing the predetermined information in a pop-up dialog box on the display displaying the moving map; and
pictorially providing the predetermined information on the display displaying the moving map.

25. The method of claim 22, wherein providing predetermined information comprises audibly presenting the predetermined information to the occupant via an audio device when the occupant selects a given one of information icons.

26. The method of claim 22, wherein providing predetermined information comprises:
associating each information icon with the predetermined information that has been incorporated into at least one information manual;
identifying a plurality of portions of the predetermined information within the information manual with an identifier that corresponds to an associated information icon; and
providing the occupant access to the information manual, wherein the occupant can locate a desired portion of the predetermined information that relates to a point of interest identified by the information icon.
